(19) United States
(12) Patent Application Publication
(10) Pub. No.: US 2024/0421843 A1
(43) Pub. Date: Dec. 19, 2024

(54) DEVICE ARRANGEMENT AND USE OF A GEL

(71) Applicant: ECOM Instruments GmbH, Assamstadt (DE)

(72) Inventor: Axel Sailer, Weikersheim (DE)

(21) Appl. No.: 18/704,912

(22) PCT Filed: Oct. 21, 2022
(86) PCT No.: PCT/EP2022/079427

§ 371 Date: Apr. 25, 2024

(30) Foreign Application Priority Data
Oct. 26, 2021 (DE) 10 2021 212 082.2

(51) Int. Cl. H04B 1/3888; G06F 1/16

(52) U.S. Cl. CPC H04B 1/3888; G06F 1/1656; G06F 2200/1634

(57) ABSTRACT

A device arrangement for, e.g., a potentially explosive area, is disclosed. The device arrangement includes an electronic device including a display. A cover is arranged on a touch-sensitive visible surface of the display. The cover includes a transparent cover plate. A transparent gel is arranged between the cover plate and the touch-sensitive visible surface of the display in a sandwich-like manner.

### CROSS-REFERENCE TO RELATED APPLICATIONS

This application claims priority to International Application No. PCT/EP2022/079427 filed Oct. 21, 2022, which also claims priority to German Patent Application DE 10 2021 212 082.2 filed Oct. 26, 2021, the contents of each of which is hereby incorporated by reference in its entirety.

### TECHNICAL FIELD

The invention relates to a device arrangement and the use of a gel for such a device arrangement.

### BACKGROUND

Modern computers, subsumed under the term “electronic device” in connection with the present application, are to an increasing extent being produced in the form of what are known as tablet computers—also termed “tablets” for simplicity in expert circles. Such a tablet is a portable computer with flat geometry, which has a touch-sensitive display which is designed in the form of a touchscreen. The display of the tablet is simultaneously used as input unit, which makes the separate provision of a keyboard or a mouse superfluous. The scope of performance of tablets of the latest generation is similar to that of modern smartphones, which is why tablets and smartphones can often only be distinguished from one another vaguely. In addition to the display, such electronic devices often have a separate electromechanical or electronic input device, such as buttons. Such a button typically functions as a home button and actuating the home button makes it possible to call up a start menu for display on the display of the electronic device.

Owing to their simple and intuitive handling, tablet computers and similar electronic devices are also being used to an increasing extent as equipment in areas with potentially explosive atmospheres, such as for example drilling rigs or the like. For all electronic devices which are used in such areas with potentially explosive atmospheres, requirements, which are defined in the DIN standard EN 60079-0 among others, apply with regards to the mandatory mechanical strength of the devices. However, the displays of conventional commercially available tablet PCs or similar electronic devices in particular do not meet the minimum requirements specified in this standard.

One option for increasing the mechanical strength of the display of such an electronic device consists, in the conventional manner, in attaching an additional transparent glass plate with high glass hardness to the top side of the electronic device. However, detection of the user touching the display, which is absolutely necessary in a touchscreen, proves problematic in connection with such an additional glass plate. In conventional tablets, this typically takes place by means of surface capacitive signal detection. If an additional glass plate is then attached on the actual display, then there is the risk that the required signal coupling between the user, when the user touches the display or the glass plate attached thereon, and the electronic device is no longer ensured with sufficient accuracy.

Against this background, the patent of the applicant with the number DE 10 2014 205 887 B4 proposes adhesively bonding a sandwich construction having two transparent glass cover plates and a liquid arranged therebetween onto a touch-sensitive visible surface of a display of an electronic device.

It has disadvantageously been shown however in case of the previously mentioned solution that an intermediate space between the cover plates, which accommodates the liquid, can only be sealed against the leakage of the liquid in a technically complex manner. Such a leakage can at worst lead to an electrical short circuit in the electronic device, which is to be avoided urgently in particular when used in an area with potentially explosive atmosphere owing to the associated risk of fire. Furthermore, in the case of the known sandwich construction, additional input devices with respect to the display on a display-side front of the device typically become unusable, as the cover plates impair or even completely prevent accessibility of such an input device. The at least impaired accessibility of such an input device above all stems from it being necessary in the case of the known sandwich construction to keep a distance between its two cover plates—the display cover plate and what is known as the “d-housing” cover plate—comparatively small owing to the electrical properties of the liquid, particularly the dielectric constant and the electric field losses. As a consequence of these electrical properties of the liquid, a thickness of the cover plates typically has an upper limit in the known sandwich construction, as in the case of cover plates which are too thick, it would no longer be possible to ensure the required signal coupling between user and display of the device to a satisfactory extent.

An object of the present invention is therefore to show novel approaches for a device arrangement having an electronic device and for the use of a gel for such a device arrangement, which novel approaches take account of the previously explained problems in particular.

This object is achieved by the subject matter of the independent claim(s). Preferred embodiments are the subject matter of the dependent patent claims.

### SUMMARY

Accordingly, the basic idea of the invention is to equip a device arrangement having an electronic device and having a transparent cover and to configure it such that the cover covers over the display of the device, wherein the cover comprises a gel which connects a touch-sensitive visible surface of the display to a transparent cover plate of the cover. In this case, the invention is further based on the general idea that the gel functions as a dielectric of an electrical capacitor, wherein the capacitor is formed by the cover plate, the gel and the display.

Advantageously, a cover of the display which is particularly strong mechanically can be achieved in this manner, which is why the device arrangement can be realized in a particularly robust manner mechanically. In addition, the gel is attractive compared to a liquid, with excellent electrical properties, which benefits a further increase of the mechanical strength of the cover and allows a greater thickness of the cover plate without impairing the required signal coupling between user and display of the device too strongly. Rather, it has even been shown that the signal coupling between user and display in the device arrangement according to the invention can be substantially the same as that which is achieved when the cover with gel and cover plate is omitted. Furthermore, the use of a gel brings about advantages for the device arrangement in terms of sealing technology.

A device arrangement according to the invention, particularly for an area with potentially explosive atmosphere, comprises an electronic device having a display, particularly a tablet computer. Furthermore, the device arrangement comprises a transparent cover which is arranged on a touch-sensitive visible surface of the display. Preferably, the cover bears against the touch-sensitive visible surface of the display so as to cover over the visible surface. In this case, the cover has a transparent cover plate, wherein a transparent gel of the cover is arranged between the cover plate and the visible surface of the display in a sandwich-like manner. The term “transparent” may in this case in particular include all materials which transmit light which is visible for the human eye at least to some extent. The term “gel” in the present context designates a substance mixture having a liquid phase and having a solid phase. The liquid phase may comprise one or more, in each case transparent and highly permittive liquids. The solid phase may comprise a nanoscale gelling agent and in particular additional nanoscale highly permittive substances. The gel used here differs from adhesives in that electric fields are very much better conducted.

As already mentioned previously, the device arrangement according to the invention advantageously proves to be particularly mechanically robust. In particular, because of the advantageous properties of the gel to conduct electric alternating fields, an increased thickness of the cover plate can be realized compared to the prior art. Furthermore, the device arrangement according to the invention advantageously allows excellent signal coupling between user and the touch-sensitive display of the device, which qualitatively can substantially even correspond to the signal coupling between user and the display of the device which exists without a cover. Furthermore, if the gel is used, sealing of the device arrangement against leakage of the gel can be implemented in a technically particularly simple manner.

The cover plate is expediently produced from a, particularly hardened, glass or a transparent ceramic or a combination of both, particularly with a suitable dielectric constant. A cover having such a cover plate proves particularly robust with respect to local mechanical loading, as such mechanical loading may prevail for example in the case of an impact, caused by a fall, of the device arrangement against a hard substrate.

A particularly high mechanical strength of the cover is achieved in an advantageous development of the device arrangement if the glass of the cover plate has a glass hardness of at least 600 HV-02/20, preferably of at least 680 HV-02/20, at most preferably of at least 780 HV-02/20, wherein “HV” designates the Vickers hardness of the glass. A device arrangement having such a cover proves particularly robust.

According to an advantageous development of the device arrangement, the touch-sensitive visible surface of the display is operatively connected by means of the gel and the cover plate to an outer surface of the cover, which faces away from the gel, so that the touch sensitivity of the visible surface is transferred to the outer surface. This ensures the functionality of the touch function of the display.

In a further preferred development of the device arrangement, the cover plate and the display delimit a gap-like intermediate space with respect to a normal direction running perpendicular to the display. A peripheral sealing frame is arranged in the intermediate space between cover plate and display, which sealing frame encloses an accommodating space of the intermediate space in a gel-tight manner. In this case, the gel is arranged in the accommodating space such that it is filled completely. This promotes the transfer of the touch sensitivity from the visible surface to the outer surface of the cover plate.

A further advantageous development of the device arrangement provides that the gel in the accommodating space has a gel height measured along the normal direction. The gel height is at most 5 mm, preferably at most 2 mm. Advantageously, a particularly large mechanical buffer distance between cover plate and display can be provided on the one hand by means of such a gel height. In addition, away from the gel, a sufficiently large free space is created for actuating an input element of the device, which is present in or on this free space.

In a further preferred development of the device arrangement, it is provided that the cover has a protrusion which protrudes beyond the display transversely to the normal direction. In this case, the protrusion and a device section of the device which adjoins the display delimit a free space which extends the intermediate space in a gap-like manner transversely to the normal direction. The protrusion is expediently formed exclusively by the cover plate of the cover. Advantageously, the free space can therefore be mechanically shielded by means of the cover, particularly the cover plate.

According to a further preferred development of the device arrangement, the device comprises an electronic or electromechanical input device, particularly a button which is arranged in the device section and which can be actuated along the normal direction by a user of the device. Furthermore, the device arrangement comprises a transfer mechanism which bridges the free space and can be actuated manually from outside the free space, wherein the transfer mechanism transforms its manual actuation into an actuation of the input device. Advantageously, the functionality of the input device can thus be ensured even if the cover is attached in a retofitting manner to an existing electronic device with formation of the device arrangement.

In a further advantageous development of the device arrangement, the transfer mechanism has a lever which at one end is mounted outside of the free space in a pivotable manner about an axis and which at the other end is operatively connected to the input device. A transfer mechanism of this type can be implemented in a technically particularly simple manner.

According to a further preferred development of the device arrangement, the transfer mechanism comprises an actuating body which is supported on the lever, particularly between the two ends of the lever, and which can be moved by manual actuation of the transfer mechanism, preferably linearly along the normal direction. In this case, the lever transfers a movement of the actuating body to the input device. This allows a particularly good operability of the transfer mechanism and therefore, indirectly associated therewith, also the input element.

In a further advantageous development of the device arrangement, it is provided that the display comprises a transparent display cover which encompasses the visible surface of the display, wherein the display cover is preferably formed essentially in the same way as the cover plate. Such a device arrangement proves particularly mechanically robust.

According to a further preferred development of the device arrangement, the cover plate has a plate thickness which is between 0.1 mm and 2 mm, preferably between 0.5 mm and 1.5 mm, preferably between 1 mm and 1.8 mm. This likewise has a beneficial effect on the mechanical strength of the cover.

In a further advantageous development of the device arrangement, the gel comprises a liquid polymer, preferably a polyether of ethane diol, most preferably polyethylene glycol 200. A polymer of this type has particularly suitable, particularly chemical and mechanical and electrical material properties, such as:
1. High dielectric constant,
2. Small dielectric loss angle,
3. Good optical property, particularly contrast-increasing,
4. No hazard classification.

The gel expediently contains viscosity-increasing nanoparticles, which are known as gelling agents and preferably comprise silicon dioxide or consist of silicon dioxide. The viscosity of the gel can advantageously be increased by means of these nanoparticles, which simplifies sealing of the accommodating space against leakage of the gel.

In a further preferred development of the device arrangement, the same comprises an open housing which partially delimits a housing interior. In this case, the device is arranged in the housing interior. The cover closes an opening of the housing, particularly in a fluid-tight manner. Advantageously, the electronic device can therefore be particularly effectively protected from environmental influences by means of the cover and the housing. Conversely, the environment can also be protected from any sources of danger caused by the device.

In a further advantageous development of the device arrangement, it is provided that the transfer mechanism is set up for transforming its manual actuation from an external environment that is separated from the housing interior by means of the housing and by means of the cover. A transformation ratio, under which the transfer mechanism transforms its manual actuation into the actuation of the input device can amount to greater than or equal to or less than one. Therefore, the functionality of the input element can be maintained even in the case of a device that is isolated from the external environment in a fluid-tight manner by means of the housing and the cover.

In a further preferred development of the device arrangement, a gap-like interstice is present at least in some regions between the housing and the device away from the display, which interstice is at least partially filled with an elastic filling medium. By means of the filling medium, the device can be fixed in a “floating” manner in the housing interior particularly well, wherein the elastic filling medium can be used at the same time for damping a relative movement of the device to the housing, which is permitted in a targeted manner.

The elastic filling medium expediently comprises a two-component silicone and at least one selected from titanium oxide, barium titanate and strontium titanate. Such a filling medium advantageously has a particularly high dielectric constant.

According to a further advantageous development of the device arrangement, cover plate, gel and display form an electrical capacitor having a dielectric, wherein the dielectric is formed at least to some extent by the gel. In this case, the capacitor is formed in such a manner that the dielectric constant of the electrical capacitor decreases and the electrical quality of the capacitor increases with increase of the frequency of an AC voltage, particularly an electric square wave voltage, applied at the cover and display of the electrical capacitor. Accordingly, the capacitor is formed in such a manner that an electrical quality of the electrical capacitor increases and the dielectric constant of the capacitor decreases with decrease of the frequency of an AC voltage, particularly an electric square wave voltage, applied at the cover and display of the electrical capacitor.

This has an advantageous effect on the touch sensitivity of the display which is transferred to the outer surface of the cover plate by means of the gel.

Expediently, a frequency-dependent dielectric constant of the dielectric amounts to approximately 129 and a frequency-dependent electrical quality amounts to approximately 0.35 if the frequency is 200 kHz. Alternatively or additionally, the frequency-dependent dielectric constant amounts to approximately 30 and the electrical quality amounts to approximately 0.88 if the frequency is 600 kHz. Alternatively or additionally, the frequency-dependent dielectric constant amounts to approximately 12 and the electrical quality amounts to approximately 1.8 if the frequency is 1.4 MHz. The display can be operated particularly precisely by means of an electrical capacitor of the device arrangement realized in such a manner.

According to a further advantageous development of the device arrangement, the cover plate is designed in a coating-free manner at least on its outer surface which faces away from the gel. In this way, images that are displayed on the display and viewed through the cover can appear particularly brilliant.

In addition, the invention relates to the use of a gel for a previously explained device arrangement in the sense of the invention, particularly as a dielectric of an electrical capacitor with dielectric, which is formed by cover plate, gel and display of the device arrangement. By means of the use according to the invention, it is possible to utilize the previously indicated advantages of the device arrangement according to the invention.

Further important features and advantages of the invention result from the dependent claims, from the drawing and from the associated description of the FIGURE with reference to the drawing.

It is understood that the previously mentioned features and the features which are still to be explained in the following, can be used not only in the respectively specified combination, but also in other combinations or alone, without departing from the scope of the present invention.

### BRIEF DESCRIPTION OF THE DRAWING

In the drawing, in this case schematically:

The FIGURE shows a section view of a device arrangement according to the disclosure.

### DETAILED DESCRIPTION

Preferred exemplary embodiments of the invention are illustrated in the drawing and are explained in more detail in the following description.

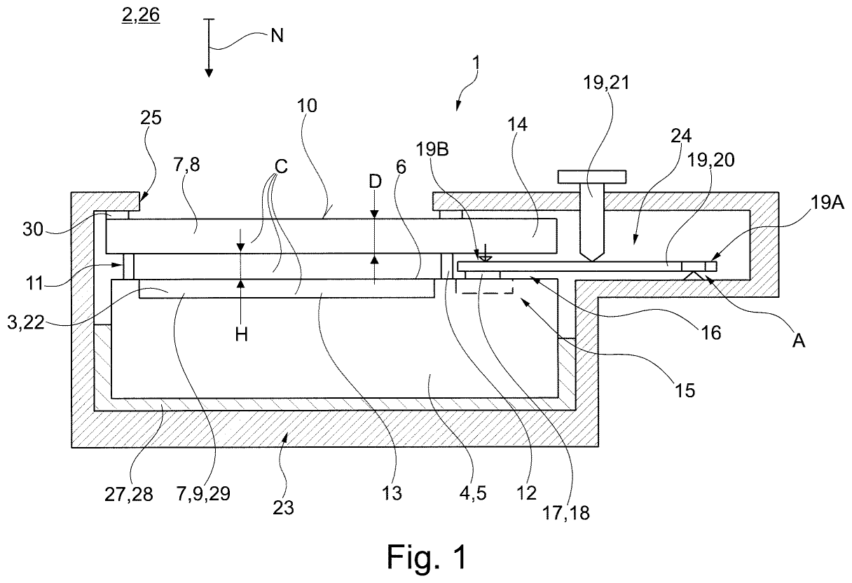

The single FIG. 1 shows an example of a device arrangement 1 according to the invention in a rough schematic sectional illustration. The device arrangement 1 is set up for use inside an area 2 with potentially explosive atmosphere. The device arrangement 1 comprises an electronic device 4 which has a display 3. The display 3 may be a capacitive touchscreen. The electronic device 4 in the example of FIG. 1 is a tablet computer 5.

The device arrangement 1 additionally comprises a cover 7. The cover 7 is arranged on a touch-sensitive visible surface 6 of the display 3. The cover 7 can bear against the visible surface 6—so as to cover over a touch-sensitive visible surface 6 of the display 3. For example, the cover 7 protrudes beyond the visible surface 6 on all sides. The cover 7 comprises a transparent cover plate 8 and a transparent gel 9. In this case, the transparent gel 9 of the cover 7 is arranged in a sandwich-like manner between the cover plate 8 of the cover 7 and the visible surface 6 of the display 3 of the device 4.

In the example of FIG. 1, the touch-sensitive visible surface 6 of the display 3 is operatively connected by means of the gel 9 and the cover plate 8 to an outer surface 10 of the cover 8, which faces away from the gel 9. This means that the touch sensitivity of the visible surface 6 is transferred to the outer surface 10. A user of the device 1 can therefore indirectly actuate the touch-sensitive visible surface 6 of the display 3 by touching the outer surface 10 and in this way operate the device 4 or the tablet computer 5. The outer surface 10 can therefore be used as an operating panel for touch operation of the device 4 by means of its display 3. In the example scenario, the cover plate 8 is designed to be coating-free at least at its outer surface 10 which faces away from the gel 9.

In this case, the gel 9 comprises a liquid polymer for example. Such a liquid polymer can be a polyether of ethane diol. In the example of FIG. 1, the polymer is polyethylene glycol 200 or—expressed by the associated structural formula —HO—(C2H4O)n-H. The gel 9 for example contains viscosity-increasing nanoparticles which may comprise silicon dioxide or consist of silicon dioxide. The nanoparticles can be dispersed in the gel 9 or in the polymer of the gel 9. The gel 9 may be thixotropic. The gel 9 may be gelatinous.

It can further be seen from FIG. 1 that the cover plate 8 and the display 3 delimit a gap-like intermediate space 11 with respect to a normal direction N running perpendicular to the display 3. A peripheral sealing frame 12 is arranged in this intermediate space 11 between the cover plate 8 and the display 3, which sealing frame encloses an accommodating space 13 of the intermediate space 11 in a gel-tight manner. The accommodating space 13 is therefore a subspace of the intermediate space 11 in the example shown. In this case, the gel 9 is arranged in the accommodating space 13. In the example shown, the gel 9 fills the accommodating space 13 completely. The accommodating space 13, which is filled completely by the gel 9, must be free from air or other gas bubbles. According to the example of FIG. 1, the gel 9 in the accommodating space 13 has a gel height H measured along the normal direction N. A height of the accommodating space 13, which is measured along the normal direction N, may correspond to the gel height H. The gel height H is between 0.5 mm and 2.5 mm. In the example shown, the gel height H is approximately 2 mm.

It can additionally be seen from FIG. 1 that the cover 7 has a protrusion 14 which protrudes beyond the display 3 transversely to the normal direction N. The protrusion 14 is for example formed exclusively by the cover plate 8 and protrudes beyond the gel 9 and the display 3 transversely to the normal direction N. In this case, the protrusion 14 and a device section 15 of the device 4, which adjoins the display 3, delimit a free space 16 which extends the intermediate space 11 in a gap-like manner transversely to the normal direction N. A height of the free space 16, which is measured along the normal direction N, may correspond to the gel height H.

The device 4 which is shown by way of example in FIG. 1 comprises an electromechanical input device 17. The input device 17 is for example realized as a button 18 or comprises a button 18. The input device 17 can be a home button. The electromechanical input device 17 is arranged in the device section 15 and can be actuated along the normal direction N by a user of the device 4. The device arrangement 1 furthermore comprises a transfer mechanism 19 which can be actuated manually and which bridges the free space 16 and can be actuated manually from outside the free space 16. In this case, the transfer mechanism 19 transforms its manual actuation into an actuation of the input device 17. A transformation ratio, under which the transfer mechanism 19 transforms its manual actuation into the actuation of the input device 17 can amount to greater than or equal to or less than one.

In the example of FIG. 1, the transfer mechanism 19 comprises a lever 20. The lever 20 is mounted at one end 20A outside of the free space 16 in a pivotable manner about an axis A. At the other end 20B, the lever 20 is operatively connected to the input device 17. The axis A can extend transversely to the normal direction N. The transfer mechanism 19 for example comprises a movable actuating body 21. The actuating body 21 is supported on the lever 19. The actuating body 21 can be supported on the lever 19 between the two ends 20A, 20B of the lever 19. The actuating body 21 can for example be moved linearly along the normal direction N. In this case, the lever 20 transfers a movement of the actuating body 21 to the input device 17.

According to FIG. 1, the display 3 comprises a transparent display cover 22. The display cover 22 encompasses the visible surface 6 of the display 3. In this case, the display cover 22 can be formed essentially in the same way as the cover plate 8. For example, the display cover 22 can consist of a same material as the cover plate 8 and—alternatively or additionally—have a same plate thickness D measured along the normal direction N as the cover plate 8. The plate thickness D of the cover plate 8 amounts to between 0.1 mm and 2 mm. The plate thickness D of the cover plate 8 may for example be between 0.5 mm and 2.5 mm. In the example shown, the plate thickness D is between 0.5 and 1.8 mm.

It can further be seen from FIG. 1 that the device arrangement 1 comprises an open housing 23. The housing 23 partially delimits a housing interior 24. In this case, the device 4 is arranged in the housing interior 24. The cover 8 closes an opening 25 of the housing 23. For example, the opening 25 of the housing 23 is closed in a fluid-tight manner by means of the cover 8. The cover 8 can be attached to the housing 23 from the housing interior 24 so as to close the opening 25. A peripheral seal 30, which encloses the opening 25, can be arranged between housing 23 and the cover 8. In this case, the transfer mechanism 19 is set up for transforming its manual actuation from an external environment 26 that is separated from the housing interior 24 by means of the housing 23 and by means of the cover 7. The external environment 26 may correspond to the area 2 with potentially explosive atmosphere.

In addition, it can be seen from FIG. 1 that a gap-like interstice 27 is present at least in some regions between the housing 23 and the device 4 away from the display 3. For example, the gap-like interstice 27 is present between a housing base of the housing 23 and a rear side of the device 4. The interstice 27 is at least partially filled with an elastic filling medium 28. In the example of FIG. 1, the elastic filling medium 28 comprises a two-component silicone and at least one chosen from titanium dioxide, barium titanate and strontium titanate.

As furthermore shown in FIG. 1, the cover plate 8, the gel 9 and the display 3 together form an electrical capacitor C having a dielectric 29. In this case, the dielectric 29 is formed at least to some extent by the gel 9. The sealing frame 12 and the free space 16 can also constitute part of the dielectric 29. The capacitor C can be realized in the manner of an electrical plate capacitor, the plates of which are formed by the cover plate 8 and the display 3 and its dielectric 29 is formed at least to some extent by the gel 9.

In this case, the capacitor C according to FIG. 1 is formed in such a manner that an electrical quality of the electrical capacitor C experiences a compensating change in the same direction in the event of a change in a frequency of an electrical AC voltage applied at the cover 8 and display 3 of the electrical capacitor C and that a dielectric constant of the gel 9 experiences a change in the opposite direction in the event of a change in the frequency.

For example, a frequency-dependent dielectric constant of the dielectric 29 amounts to approximately 129 and a frequency-dependent electrical quality amounts to approximately 0.35 if the frequency is 200 kHz. At a frequency of 600 kHz, the frequency-dependent dielectric constant may amount to approximately 30 and the electrical quality may amount to approximately 0.88. At a frequency of 1.4 MHz, the frequency-dependent dielectric constant may amount to approximately twelve and the electrical quality may amount to approximately 1.8.

The gel that can be seen by way of example in FIG. 1 is used according to the invention for a device arrangement 1 according to the invention, as such has likewise been shown in FIG. 1 and described previously. In this case, the gel 9 can be used for the or as the dielectric 29 of the electrical capacitor C with dielectric 29, which is formed by the cover plate 8, the gel 9 and the display 3.

1. A device arrangement, comprising:
an electronic device including a display,
a cover arranged on a touch-sensitive visible surface of the display,
wherein the cover comprises a transparent cover plate and a transparent gel of the cover is arranged between the cover plate and the touch-sensitive visible surface of the display in a sandwich-like manner.

2. The device arrangement according to claim 1, wherein the touch-sensitive visible surface of the display is operatively connected via the gel and the cover plate to an outer surface of the cover, the outer surface faces away from the gel, so that a touch sensitivity of the touch-sensitive visible surface is transferred to the outer surface.

3. The device arrangement according to claim 1, wherein:
the cover plate and the display delimit a gap-like intermediate space with respect to a normal direction running perpendicular to the display,
a peripheral sealing frame is arranged in the intermediate space between cover plate and display, the peripheral sealing frame encloses an accommodating space of the intermediate space in a gel-tight manner, and
the gel is arranged in the accommodating space.

4. The device arrangement according to claim 3, wherein
the gel in the accommodating space has a gel height measured along the normal direction, and
the gel height is between 0.2 mm and 2 mm.

5. The device arrangement according to claim 3, wherein:
the cover has a protrusion protrudes beyond the display transversely to the normal direction, and
the protrusion and a device section of the electronic device,
which adjoins the display, delimit a free space which extends the intermediate space in a gap-like manner transversely to the normal direction.

6. The device arrangement according to claim 5, wherein:
the electronic device (4) comprises an electromechanical input device that is arranged in the device section and can be actuated along the normal direction by a user, and
a transfer mechanism is provided that bridges the free space and can be actuated manually from outside the free space, wherein the transfer mechanism transforms its manual actuation into an actuation of the input device.

7. The device arrangement according to claim 6, wherein the transfer mechanism comprises a lever that at one end is mounted outside of the free space in a pivotable manner about an axis and at the other end is operatively connected to the input device.

8. The device arrangement according to claim 7, wherein:
the transfer mechanism has an actuating body that is supported on the lever and can be moved by manual actuation of the transfer mechanism, and
the lever transfers a movement of the actuating body to the input device.

9. The device arrangement according to claim 1, wherein:
the display comprises a transparent display cover that encompasses the touch-sensitive visible surface of the display.

10. The device arrangement according to claim 1, wherein the cover plate has a plate thickness between 0.1 mm and 2 mm.

11. The device arrangement according to claim 1, wherein the gel comprises a liquid polymer.

12. The device arrangement according to claim 1, wherein the gel contains viscosity-increasing nanoparticles.

13. The device arrangement according to claim 1, wherein:
an open housing is provided that partially delimits a housing interior,
the electronic device is arranged in the housing interior, and
the cover closes an opening of the housing.

14. The device arrangement according to claim 6, wherein an open housing is provided that partially delimits a housing interior, and the transfer mechanism transforms its manual actuation from an external environment that is separated from the housing interior via the housing and via the cover (7).

15. The device arrangement according to claim 14, wherein a gap-like interstice is present at least in some regions between the housing and the electronic device away from the display, the interstice is at least partially filled with an elastic filling medium.

16. The device arrangement according to claim 15, wherein the elastic filling medium comprises a two-component silicone and at least one selected from titanium oxide, barium titanate and strontium titanate.

17. The device arrangement according to claim 1, wherein:
cover plate, the gel and display form an electrical capacitor having a dielectric, wherein the dielectric is formed at least to some extent by the gel,
the electrical capacitor is formed such that the dielectric constant of the electrical capacitor experiences a change in the same direction in the event of a change of a frequency of an AC voltage applied at the cover and the display of the electrical capacitor and that a dielectric constant of the gel experiences a change in the opposite direction in the event of a change in the frequency.

18. The device arrangement according to claim 17, wherein at least one of:
at a frequency of 200 kHz, a frequency-dependent dielectric constant of the dielectric is approximately 129 and an electrical quality is approximately 0.35;
at a frequency of 600 kHz, the frequency-dependent dielectric constant of the dielectric is approximately 30 and the electrical quality is approximately 0.88; and
at a frequency of 1.4 MHz, the frequency-dependent dielectric constant of the dielectric is approximately 12 and the electrical quality is approximately 1.8.

19. The device arrangement according to claim 1, wherein the cover plate is coating-free at least at an outer surface that faces away from the gel.

20. A device arrangement, comprising:
a tablet computer including a display,
a cover arranged on a touch-sensitive visible surface of the display, the cover comprising a transparent cover plate,
a transparent gel arranged between the cover plate and the touch-sensitive visible surface of the display in a sandwich-like manner,
wherein the gel is a dielectric of an electrical capacitor, the electrical capacitor being formed by the cover plate, the gel and the display.
